(19) United States
(12) Patent Application Publication
(10) Pub. No.: US 2002/0152158 A1
(43) Pub. Date: Oct. 17, 2002

(54) Digital money with usage-control

(75) Inventors: Ilan Paleiov, Kfar Vradim (IL); Amir Angel, Holon (IL)

Correspondence Address: DARBY & DARBY P.C., 805 Third Avenue, New York, NY, 10022, US

(73) Assignee: INTERNATIONAL BUSINESS MACHINES CORPORATION

(21) Appl. No.: 09/835,781

(22) Filed: Apr. 12, 2001

(51) Int. Cl. G06F 17/60

(52) U.S. Cl. 705/39; 705/26

(57) ABSTRACT

A method for enabling financial transactions is provided. The method includes providing an electronic monetary token having one or more data fields associated therewith, the one or more data fields defining respective characteristics of an item of goods or services for purchase, such that a user of the token is enabled to designate data to be stored in at least one of the one or more data fields, so as to restrict items for which the token can be used to make a purchase.

### FIELD OF THE INVENTION

The present invention relates generally to electronic financial transactions, and specifically to methods and apparatus for enabling electronic financial transactions over a public network.

### BACKGROUND OF THE INVENTION

There are numerous methods known in the art for enabling financial transactions over a public network. One example is presented in U.S. Pat. No. 6,000,832 to Franklin et al., entitled “Electronic online commerce card with customer generated transaction proxy number for online transactions,” which is incorporated herein by reference. The Franklin patent describes a system which facilitates online commerce over a public network using an online commerce card.

Similarly, U.S. Pat. No. 5,845,281 to Benson et al., which is incorporated herein by reference, describes methods for buying, selling, and encrypting data objects.

There is also a demand for services which enable adults and children to make safe and controlled purchases over a public network. U.S. Pat. No. 5,953,710 to Fleming, which is incorporated herein by reference, describes a children's credit or debit card system, which enables someone other than the card issuer to determine or limit the available credit.

Another example of controlled purchasing is described in PCT Patent Publication WO 99/49424, entitled “Credit card system and method,” to Flitcroft et al., which is incorporated herein by reference. The Flitcroft publication describes a system in which a credit card owner designates certain restrictions for a credit card which is given to another person. For example, a credit card is described which is deactivated if it is used with a frequency above a given threshold. In addition, a single-use credit card is described having other limits to its validity, such as geographical location.

Australian Patent Application AU 199928128-A1 to Schmidt, entitled, “One-time-use payment card and method,” which is incorporated herein by reference, describes a method for issuing a payment card which is to be used exactly one time, e.g., to pay for a single taxi trip. Techniques for eliminating repeat use of the card and/or for punishing vendors who inappropriately allow a second use of the card are fundamental to the disclosure of the Schmidt application.

Another field of commerce which is expanding via the Internet is that of online gift certificates. These are typically electronic versions of traditional physical gift certificates. Thus, they are generally bought by a gift certificate donor and sent electronically or physically to an intended receiver.

### SUMMARY OF THE INVENTION

It is an object of some aspects of the present invention to provide improved apparatus and methods for enabling electronic financial transactions.

It is a further object of some aspects of the present invention to provide improved apparatus and methods for enabling and regulating electronic financial transactions made over a public network.

It is yet a further object of some aspects of the present invention to provide improved security of electronic financial transactions made over a public network.

In preferred embodiments of the present invention, an electronic monetary token comprises one or more data fields, each field corresponding to a respective type of transaction. An owner or user of the token, a person adding value to the token, or another entity, as appropriate, is preferably enabled to designate data to be stored in at least one of the fields, so as to restrict the types of transactions for which some or all of the value in the token can be used.

Thus, in accordance with these embodiments, a donor (such as a parent or an employer) is preferably enabled to exercise a significant level of control over money which is being given to a recipient. For example, a mother may give her son an electronic monetary token for purchasing items of goods or services including:

(a) $40 for school supplies,

(b) $25 for food bought on weekdays, between 11 AM and 1 PM, no single day to exceed $5,

(c) $60 for any products bought from Web sites having a child-friendly certificate, no purchases to be made during school hours,

(d) $30 for downloading movies, up to two movies per week,

(e) $40 for use of a tutoring service,

(f) $59.99 for a particular, identified product of known price, and

(g) $30 of unrestricted money.

Alternatively, an employer may designate appropriate limitations on a $1,500 token given to an employee leaving for a business trip. These limitations may include, for example, designations of $600 for airline tickets, $75 for trip insurance, $250 for restaurants in Chicago during a particular week, and $150 for taxi services during the same week. Preferably, but not necessarily, when the business trip has ended, the employee could return the token to the employer, and the employer could use a password or other means to erase the limitations on any remaining value in the token.

Thus, these embodiments preferably provide a donor with the ability to pre-define restrictions related to both the product or product class of a real or virtual purchase, and, additionally, characteristics of the transaction itself (such as the date, vendor, or the location). By contrast, prior art methods only allow a donor very limited control, e.g., by purchasing a gift certificate from a local store or from a virtual store, or by designating a spending limit or purchase frequency for a child's credit card.

In some preferred embodiments of the present invention, the electronic monetary token comprises or is associated with an electronic memory, which is segmented in accordance with the desired types of transaction restrictions that may be applied to the token. These may include, for example, designations of permitted and forbidden fields of purchase. A purchase transaction is preferably enabled only if the purchase complies with the data in all of the relevant permitted fields (e.g., a specification of restaurants in a given zip code), and does not violate the restrictions imposed by the data in the relevant forbidden fields (e.g., restrictions on purchases during school hours, or on the purchase of alcohol and cigarettes).

Typically, but not necessarily, a token distributor issuing the electronic monetary tokens defines a standard classification system of permitted and forbidden fields of purchase, such that a parent or other donor can simply select the relevant fields and enter appropriate data therein, prior to giving the token to a recipient. Alternatively, the donor adds money with appropriate restrictions to a token already owned by the recipient.

In some preferred embodiments of the present invention, the electronic monetary token comprises a housing, such as a plastic card, to which is affixed the electronic memory, and, optionally, a microprocessor and other circuitry known in the art of smart cards. Means for adding value to the card and removing value from the card are typically generally similar to those utilized with smart cards, but further include the transaction-restriction features described herein.

In other preferred embodiments, the electronic monetary token is, in its physical form, substantially the same as credit cards or debit cards known in the art, typically comprising a magnetic strip and imprinted user identification information. For these embodiments, the restrictions are preferably entered by the donor and saved in a memory of a remote authorization server. When a vendor in a physical store or a virtual store is presented with the identification information on the token, the vendor typically transmits relevant information regarding the proposed purchase to the authorization server. If the transaction is in accordance with any restrictions placed on the money in the monetary token, then the server sends an authorization to the vendor, allowing the vendor to conclude the proposed transaction.

In additional preferred embodiments of the present invention, the electronic monetary token is issued as an identity code and a password, and has no physical form. The information in the various fields of the token is preferably stored on a server maintained by an issuer of the token. Further preferably, the issuer maintains a Web site which allows donors to add more money to designated tokens, and which allows token holders to access information about the status of their tokens. Typically, but not necessarily, such tokens are used to enable electronic transactions, such as purchases made on the Web or by telephone.

There is therefore provided, in accordance with a preferred embodiment of the present invention, a method for enabling financial transactions, including providing an electronic monetary token having one or more data fields associated therewith, the one or more data fields defining respective characteristics of an item of goods or services for purchase, such that a user of the token is enabled to designate data to be stored in at least one of the one or more data fields, so as to restrict items for which the token can be used to make a purchase.

Preferably, the one or more data fields include a first set of one or more data fields, providing the token includes enabling the first set of one or more data fields to have a first amount of financial value associated therewith, and the method includes:

providing a second set of one or more data fields associated with the electronic monetary token, the second set of one or more data fields defining respective characteristics of a second item of goods or services for purchase; and

enabling the second set of one or more data fields to have a second amount of financial value associated therewith,

such that the user is enabled to designate data to be stored in at least one of the data fields in the second set of one or more data fields, so as to restrict items for which the second amount of financial value can be used to make a purchase.

Further preferably, the method includes restricting a second user from modifying the designated data.

In a preferred embodiment, providing the token includes enabling the user to assign an age limitation to be stored in one of the one or more data fields, so as to restrict the token from being used to purchase an item having an age designation not corresponding to the age limitation.

Alternatively or additionally, providing the token includes:

enabling the token to have an amount of financial value associated therewith; and

enabling the user to designate a particular item of goods or services, such that the amount of financial value is restricted to use for purchase of the particular item.

Further alternatively or additionally, providing the token includes:

enabling the token to have an amount of financial value associated therewith; and

enabling the user to designate a class of items of goods or services, such that the amount of financial value is restricted to use for purchase of an item of goods or services selected from the class.

In a preferred embodiment, the method includes:

associating with the token a memory located at a server remote from the user; and

storing the designated data in the memory.

For some applications, providing the token includes enabling the token to be used to facilitate a micro-payment.

The method preferably includes:

enabling the user to transfer the token to a recipient; and

restricting the recipient from modifying the data designated by the user.

However, the user is preferably enabled to modify the designated data.

In a preferred embodiment, the method includes enabling the user to associate an amount of financial value with the designated data. Preferably, enabling the user includes receiving at a Web site a designation by the user of the data and a designation of the value.

For some applications, the electronic monetary token includes a portable, physical electronic monetary token, and the method includes affixing to the portable token a memory enabled to store the designated data. Typically, the method further includes affixing an electronic processor to the portable token.

Preferably, the method includes:

receiving, with respect to the electronic monetary token, an authorization query including transaction data corresponding to a proposed transaction;

analyzing the transaction data with respect to the designated data; and

barring use of the electronic monetary token to enable the proposed transaction responsive to analyzing the transaction data.

Receiving the query typically includes receiving the query from a vendor over an electronic network.

In some preferred embodiments of the present invention, the method includes providing one or more additional data fields associated with the token, the one or more additional data fields defining respective purchase characteristics, such that the user is enabled to designate data to be stored in at least one of the one or more additional data fields, so as to restrict the token from being used to enable purchases having aspects corresponding to the purchase characteristics.

In a preferred embodiment, providing the one or more additional data fields includes providing a field corresponding to a geographical limitation associated with a purchase.

Alternatively or additionally, providing the one or more additional data fields includes providing a field corresponding to a time-related limitation associated with a purchase.

There is also provided, in accordance with a preferred embodiment of the present invention, apparatus for enabling financial transactions, including:

a memory, arranged to have one or more data fields, the one or more data fields corresponding to respective characteristics of an item of goods or services for purchase;

a data port, arranged to receive from a user a designation of data to be stored in at least one of the one or more data fields; and

a processor, arranged to disallow a financial transaction responsive to the designated data.

Preferably, (a) the one or more data fields include a first set of one or more data fields, (b) the memory is arranged to store the designated data in at least one of the one or more data fields in the first set of one or more data fields, (c) the memory is arranged to store a representation of a first amount of financial value, which is associated with the first set of one or more data fields, (d) the memory is arranged to have a second set of one or more data fields corresponding to respective characteristics of a second item of goods or services for purchase, (e) the memory is arranged to store a representation of a second amount of financial value, which is associated with the second set of one or more data fields, (f) the data port is arranged to receive from the user a designation of data to be stored in at least one of the one or more data fields in the second set of one or more data fields, (g) the data port is arranged to receive an authorization query including a characteristic of an item of goods or services proposed for purchase, and (h) the processor is arranged to evaluate the query and to allow value to be used to enable the purchase which is drawn from exactly one of: the first amount of value and the second amount of value.

In a preferred embodiment, the data port is arranged to receive from a remote vendor an authorization query including a characteristic of an item of goods or services proposed for purchase, and the processor is arranged to evaluate the query with respect to the designated data and to actuate the data port to transmit an authorization reply to the vendor responsive to evaluating the query.

For some applications, (a) the memory is arranged to store a representation of an amount of financial value, which is associated with at least one of the one or more data fields, (b) the data port is arranged to receive, with respect to the amount of financial value, a designation of a particular item of goods or services, and (c) the processor is arranged to restrict the amount of financial value to use for purchase of the particular item.

Alternatively or additionally, (a) the memory is arranged to store a representation of an amount of financial value, which is associated with at least one of the one or more data fields, (b) the data port is arranged to receive, with respect to the amount of financial value, a designation of a class of items of goods or services, and (c) the processor is arranged to restrict the amount of financial value to use for purchase of an item of goods or services selected from the class.

The processor is typically arranged to restrict a second user from modifying the designated data.

The data port is preferably arranged to receive an indication of an amount of financial value to be associated with one of the data fields in which are stored the designated data, and wherein the processor is arranged to use the amount of financial value to enable a purchase that is in accordance with the designated data.

In a preferred embodiment, the data port is arranged to receive the designation of the data from a remote site by means of an electronic network.

For some applications, the memory, data port, and processor are arranged in a single integrated unit, which is adapted to be physically presented to a vendor in order to enable a purchase.

Alternatively or additionally, the memory is arranged to have one or more additional data fields, the one or more additional data fields corresponding to respective purchase characteristics, wherein the data port is arranged to receive from the user a designation of data to be stored in at least one of the one or more additional data fields, and wherein the processor is arranged to disallow a financial transaction responsive to data designated by the user which are stored in the one or more additional data fields.

For example, the data port may be arranged to receive from the user a designation of a geographical limitation to be stored in one of the one or more additional data fields. Alternatively or additionally, the data port may be arranged to receive from the user a designation of a time-related limitation to be stored in one of the one or more additional data fields.

There is additionally provided, in accordance with a preferred embodiment of the present invention, a computer program product for enabling financial transactions, the product including a computer-readable medium having program instructions embodied therein, which instructions, when read by a computer, cause the computer to provide an electronic monetary token having one or more data fields associated therewith, the one or more data fields defining respective characteristics of an item of goods or services for purchase, such that a user of the token is enabled to designate data to be stored in at least one of the one or more data fields, so as to restrict items for which the token can be used to make a purchase.

The present invention will be more fully understood from the following detailed description of the preferred embodiments thereof, taken together with the drawings, in which:

### BRIEF DESCRIPTION OF THE DRAWINGS

FIG. 1 is a simplified pictorial illustration showing authorization apparatus for use with an electronic monetary token, in accordance with a preferred embodiment of the present invention;

FIG. 2 is a simplified pictorial illustration of an electronic monetary token embodied in a smart card, in accordance with a preferred embodiment of the present invention; and

FIGS. 3A and 3B are simplified pictorial illustrations showing respective front and reverse sides of an electronic monetary token embodied in another type of card, in accordance with a preferred embodiment of the present invention.

### DETAILED DESCRIPTION OF PREFERRED EMBODIMENTS

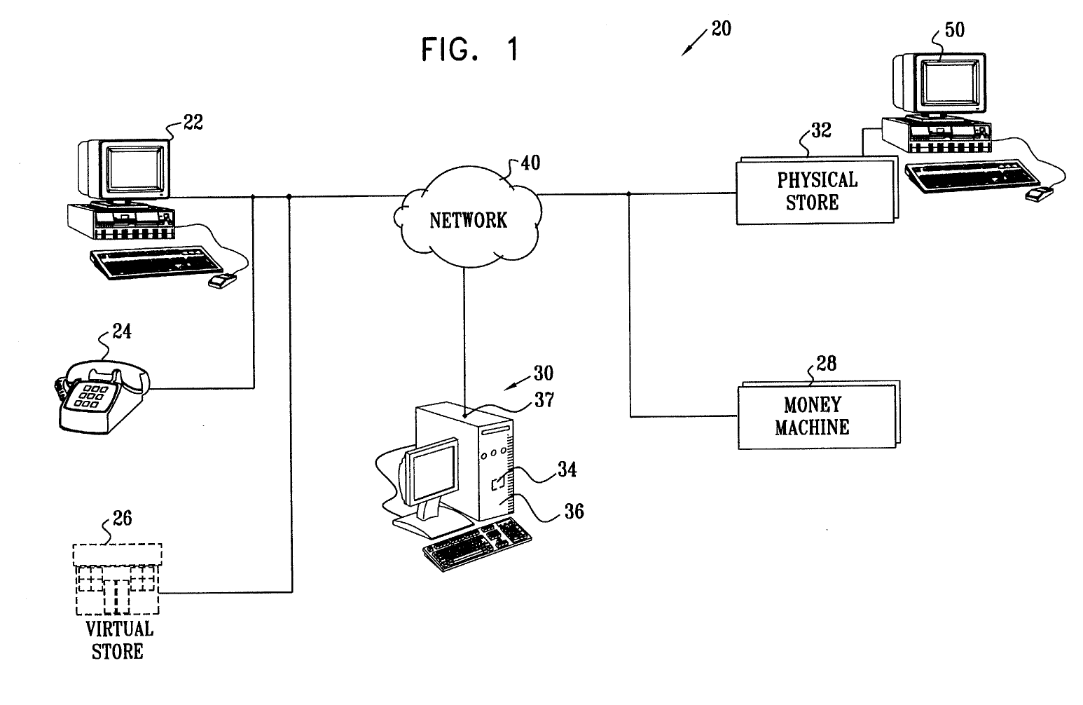

FIG. 1 is a simplified pictorial illustration showing authorization apparatus 20 for use with a range of physical and virtual electronic monetary tokens, in accordance with a preferred embodiment of the present invention. Apparatus 20 preferably comprises an authorization server 30, which communicates over an electronic network 40 with a number of remote devices or entities, such as one or more personal computers 22, a telephone 24, a virtual store 26, an automated banking machine 28, and an authorization unit 50 of a physical store 32. Server 30 is preferably configured to confirm that all purchases made using an electronic monetary token are in accordance with transaction restrictions associated with the token which were designated for the token by an owner or user of the token, a person adding value to the token, or another entity, as appropriate. These restrictions are typically, but not necessarily, stored in a memory 34 of server 30.

When, for example, an electronic monetary token is presented at the time of a purchase to an owner of physical store 32, authorization unit 50 preferably transmits a query over network 40 to server 30. The query typically includes details of the proposed purchase, as well as an identification code or other details pertaining to the token. The query is received by a data port 37 of server 30, and a processor 36 of the server evaluates the query with respect to data stored in memory 34, so as to determine whether the proposed purchase should be allowed. The evaluation may be made based on, for example, the price of the proposed purchase, the store name, the time of day, the item to be purchased, or a range of other purchase parameters which may be stored in corresponding fields in memory 34. If the proposed purchase is within the limits imposed on digital money in the token (typically as represented by data in memory 34), then the purchase is authorized, and the contents of memory 34 are updated accordingly. If the token is later presented to enable a subsequent purchase, the authorization of that purchase will be evaluated in light of the updated values stored in memory 34. It is emphasized that the principles underlying these embodiments of the present invention preferably apply regardless of the form of the token itself, e.g., whether it is embodied physically in, for example, a card, or whether it is embodied virtually, via an “electronic wallet” or other network-based purchase technique.

When a user of a token passes some of the money in his token to a token owned by another user, then the limitations assigned to that money are still in effect when the second user attempts to spend the money. In this manner, “laundering” of the restrictions placed on money in electronic monetary tokens is preferably prevented. Alternatively, authorization server 30 is configured to reject any transfers of restricted money from the token that are not performed in accordance with the requirements set when the money was placed in the token. In particular, restricted money stored in tokens typically may not be directly convertible into cash, e.g., at banking machine 28.

Preferably, the financial body or token distributor which issues electronic monetary tokens defines a classification system, including pre-defined restricted or required fields of purchase, which can be filled in by a first party (e.g., a parent or employer) in such a manner that they cannot be subsequently altered by a second party (e.g., a child or an employee). Such fields typically include, but are not limited to: (a) product type, (b) geographic location of a purchase, (c) purchasing methodology, such as purchases from physical outlet stores, purchases over the Internet, or purchases by telephone, (d) time of purchase, and (e) frequency of purchase.

Thus, for example, an electronic monetary token provided by these embodiments of the present invention may be used by a company to target its budget to enabling purchases only in specific fields, thereby enabling the company to enhance control of the appropriation of its resources. Whereas prior art techniques would typically dictate that the company would give cash and/or a generally non-restricted credit card to an employee leaving on a business trip, these embodiments of the present invention allow the company to give the employee a relatively large amount of money, but to limit most or all of it to expected purchases having pre-defined characteristics (e.g., $1,000 for the Grand Hotel, $500 for restaurants in Manhattan, $2,000 for electronic office equipment bought from one of three pre-specified office supply stores, and $250 unrestricted money). Preferably, upon the employee's return, a password unknown to the employee can be used to remove restrictions on any remaining money.

In another example, some of the money in an electronic monetary token may be limited to use for transactions having certain tax implications, for example transactions which are free of value added tax (VAT) or sales tax, or transactions which are tax deductible, such as donations to charity.

For some applications, an individual may be interested in applying restrictions to his own spending, rather than the spending of another individual. For example, a stamp collector may configure the fields in his electronic monetary token to enable him to purchase up to $100 per month of stamps.

Electronic monetary tokens as provided by these embodiments of the present invention may further be used as marketing tools. For example, a company may give away such restricted tokens to promote purchases of a new product, or patronage of a real or virtual store. Or, correspondingly, the company may add value to users' preexisting tokens, but restrict the added value to purchases of the new product. Additionally or alternatively, the tokens may be used as a marketing tool to promote sales in a specific field of purchase. For example, a dairy association may give out tokens, or add value to existing tokens, in order to promote purchases of all low-fat dairy products. Similarly, a city may distribute tokens whose memory fields are configured so as to encourage weeknight patronage of restaurants and small shops in certain neighborhoods, as well as cheaper weeknight public transportation to and from these neighborhoods.

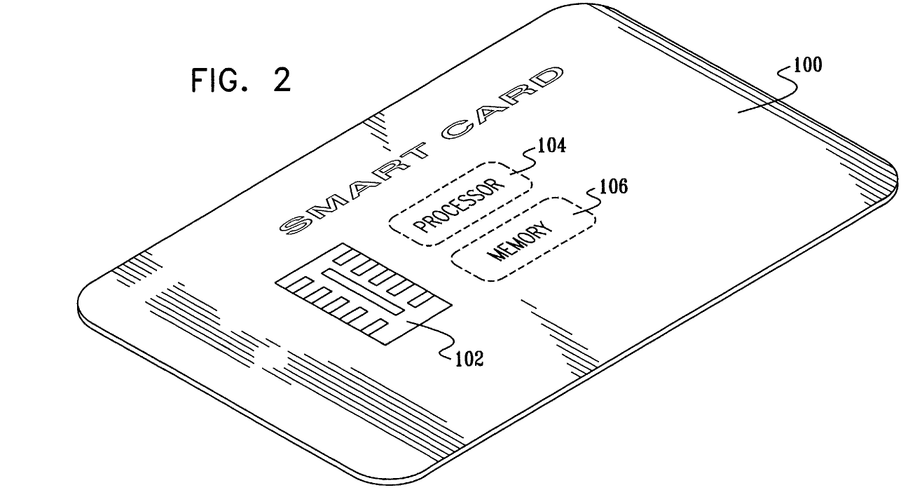

FIG. 2 is a simplified pictorial illustration of an electronic monetary token embodied in a smart card 100, in accordance with a preferred embodiment of the present invention. Smart card 100 is typically constructed to be compatible with industry standards for smart cards, e.g., comprising a direct-contact or wireless data port 102, a processor 104, and a memory 106. Means for adding value to the card and removing value from the card are typically generally similar to those utilized with smart cards known in the art, but further include the features described herein. In particular, the ability of a user of the card to spend some or all of the digital money stored in the card is preferably only performed in accordance with purchase restrictions imposed thereon by a donor of the money or by another entity.

Thus, by contrast to those applications of the present invention in which a substantial portion of the maintenance and authorization procedures associated with electronic monetary tokens are performed by server 30, in the embodiment shown in FIG. 2, processor 104 is enabled to manage the various digital moneys stored in memory 106, and to determine whether proposed transactions are in accordance with any restrictions placed thereon. Processor 104 preferably prevents transactions that are not consonant with requirements and restrictions stored in the memory, and bars unauthorized attempts to remove requirements or restrictions placed on the token.

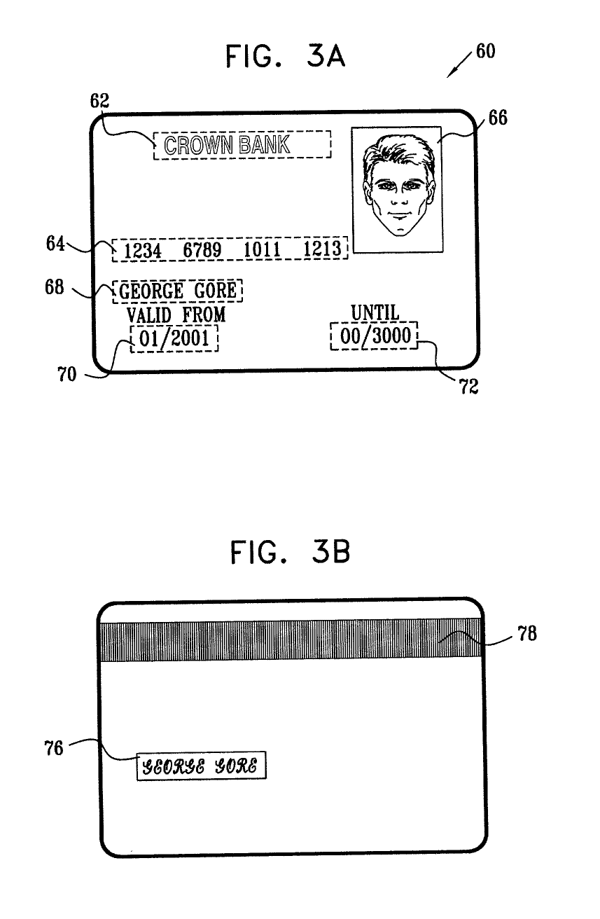

Reference is now made to FIGS. 3A and 3B, which are simplified pictorial illustrations showing respective front and reverse sides of an electronic monetary token 60, in accordance with a preferred embodiment of the present invention. Token 60 typically takes the general physical form of a credit card, debit card, or other purchase-enabling card.

It is emphasized that, while a physical card is shown in FIGS. 2, 3A, and 3B, other electronic monetary tokens (not shown) may have substantially no physical form, but may instead be issued as, for example, an identification code and a password, and have value and restrictions which are maintained in the memory of a server such as server 30, or in the memory of the user's personal computer. For both physical and non-physical electronic monetary tokens, as described herein, server 30 or another computer preferably maintains a Web site, on-screen menu, or touch-tone telephone accessible menu which allows donors to add more money to designated tokens, and which allows token holders to access information about the status of their tokens. Typically, non-physical tokens are used primarily but not exclusively to enable electronic transactions, such as purchases made by telephone, or purchases on the Web using traditional Internet payment strategies or using micro-payment strategies. Thus, virtual electronic monetary tokens as provided by preferred embodiments of the present invention preferably enable the user to have all of the functionality associated with digital money in common use today (e.g., via the metaphor of the electronic wallet), while additionally enabling a donor or other entity to apply restrictions to the digital money, as described herein.

Preferably, token 60 has some or all of the following features on its front side: the name of an organization 62 which issued the token, typically a bank or a token distribution company; an identification number 64; a security feature 66, such as a photograph of an authorized user of the card; the user's name 68; and, if appropriate, a starting date 70 and expiration date 72. Further preferably, the reverse side of token 60 is also generally similar to debit cards or credit cards known in the art, including, as appropriate, a signature box 76 and a magnetic strip 78.

For these applications, the transaction restrictions, as well as a representation of the money itself, are preferably entered by the donor or another individual, and saved in memory 34 of server 30 (FIG. 1). When, for example, a vendor in physical store 32 or virtual store 26 is presented with token 60, the vendor transmits identification number 64 and relevant information regarding the proposed purchase to server 30 via network 40. If the transaction is in accordance with all restrictions placed on money associated with the monetary token, then server 30 sends a purchase authorization to the vendor, and modifies one or more values in memory 34 to reflect that the transaction has been executed.

Optionally, token 60 is presented in different forms to suit different consumer sectors. For example, when token 60 is issued to a child, the token may have the user name 68 in very large capital letters, as well as the name and contact telephone number of a guardian. Similarly, token 60 issued to teenagers preferably has a suitable appearance appropriate for its users. For some applications, the physical appearance of the token may be made indicative of the sector of goods and services for which it was issued.

It will be understood by one skilled in the art that aspects of the present invention described hereinabove can be embodied in a computer running software, and that the software can be supplied and stored in tangible media, e.g., hard disks, floppy disks or compact disks, or in intangible media, e.g., in an electronic memory, or on a network such as the Internet.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for enabling financial transactions, comprising providing an electronic monetary token having one or more data fields associated therewith, the one or more data fields defining respective characteristics of an item of goods or services for purchase, such that a user of the token is enabled to designate data to be stored in at least one of the one or more data fields, so as to restrict items for which the token can be used to make a purchase.

2. A method according to claim 1, wherein the one or more data fields include a first set of one or more data fields, wherein providing the token comprises enabling the first set of one or more data fields to have a first amount of financial value associated therewith, and comprising:
providing a second set of one or more data fields associated with the electronic monetary token, the second set of one or more data fields defining respective characteristics of a second item of goods or services for purchase; and
enabling the second set of one or more data fields to have a second amount of financial value associated therewith,
such that the user is enabled to designate data to be stored in at least one of the data fields in the second set of one or more data fields, so as to restrict items for which the second amount of financial value can be used to make a purchase.

3. A method according to claim 1, and comprising restricting a second user from modifying the designated data.

4. A method according to claim 1, wherein providing the token comprises enabling the user to assign an age limitation to be stored in one of the one or more data fields, so as to restrict the token from being used to purchase an item having an age designation not corresponding to the age limitation.

5. A method according to claim 1, wherein providing the token comprises:
enabling the token to have an amount of financial value associated therewith; and
enabling the user to designate a particular item of goods or services, such that the amount of financial value is restricted to use for purchase of the particular item.

6. A method according to claim 1, wherein providing the token comprises:
enabling the token to have an amount of financial value associated therewith; and
enabling the user to designate a class of items of goods or services, such that the amount of financial value is restricted to use for purchase of an item of goods or services selected from the class.

7. A method according to claim 1, and comprising:
associating with the token a memory located at a server remote from the user; and
storing the designated data in the memory.

8. A method according to claim 1, wherein providing the token comprises enabling the token to be used to facilitate a micro-payment.

9. A method according to claim 1, and comprising:
enabling the user to transfer the token to a recipient; and
restricting the recipient from modifying the data designated by the user.

10. A method according to claim 9, and comprising enabling the user to modify the designated data.

11. A method according to claim 1, and comprising enabling the user to associate an amount of financial value with the designated data.

12. A method according to claim 11, wherein enabling the user comprises receiving at a Web site a designation by the user of the data and a designation of the value.

13. A method according to claim 1, wherein the electronic monetary token includes a portable, physical electronic monetary token, and comprising affixing to the portable token a memory enabled to store the designated data.

14. A method according to claim 13, and comprising affixing an electronic processor to the portable token.

15. A method according to claim 1, and comprising:
receiving, with respect to the electronic monetary token, an authorization query including transaction data corresponding to a proposed transaction;
analyzing the transaction data with respect to the designated data; and
barring use of the electronic monetary token to enable the proposed transaction responsive to analyzing the transaction data.

16. A method according to claim 15, wherein receiving the query comprises receiving the query from a vendor over an electronic network.

17. A method according to claim 1, and comprising providing one or more additional data fields associated with the token, the one or more additional data fields defining respective purchase characteristics, such that the user is enabled to designate data to be stored in at least one of the one or more additional data fields, so as to restrict the token from being used to enable purchases having aspects corresponding to the purchase characteristics.

18. A method according to claim 17, wherein providing the one or more additional data fields comprises providing a field corresponding to a geographical limitation associated with a purchase.

19. A method according to claim 17, wherein providing the one or more additional data fields comprises providing a field corresponding to a time-related limitation associated with a purchase.

20. Apparatus for enabling financial transactions, comprising:
a memory, arranged to have one or more data fields, the one or more data fields corresponding to respective characteristics of an item of goods or services for purchase;
a data port, arranged to receive from a user a designation of data to be stored in at least one of the one or more data fields; and
a processor, arranged to disallow a financial transaction responsive to the designated data.

21. Apparatus according to claim 20, wherein the one or more data fields include a first set of one or more data fields,
wherein the memory is arranged to store the designated data in at least one of the one or more data fields in the first set of one or more data fields,
wherein the memory is arranged to store a representation of a first amount of financial value, which is associated with the first set of one or more data fields,
wherein the memory is arranged to have a second set of one or more data fields corresponding to respective characteristics of a second item of goods or services for purchase,
wherein the memory is arranged to store a representation of a second amount of financial value, which is associated with the second set of one or more data fields,
wherein the data port is arranged to receive from the user a designation of data to be stored in at least one of the one or more data fields in the second set of one or more data fields,
wherein the data port is arranged to receive an authorization query including a characteristic of an item of goods or services proposed for purchase, and
wherein the processor is arranged to evaluate the query and to allow value to be used to enable the purchase which is drawn from exactly one of: the first amount of value and the second amount of value.

22. Apparatus according to claim 20, wherein the data port is arranged to receive from a remote vendor an authorization query including a characteristic of an item of goods or services proposed for purchase, and wherein the processor is arranged to evaluate the query with respect to the designated data and to actuate the data port to transmit an authorization reply to the vendor responsive to evaluating the query.

23. Apparatus according to claim 20, wherein the memory is arranged to store a representation of an amount of financial value, which is associated with at least one of the one or more data fields, wherein the data port is arranged to receive, with respect to the amount of financial value, a designation of a particular item of goods or services, and wherein the processor is arranged to restrict the amount of financial value to use for purchase of the particular item.

24. Apparatus according to claim 20, wherein the memory is arranged to store a representation of an amount of financial value, which is associated with at least one of the one or more data fields, wherein the data port is arranged to receive, with respect to the amount of financial value, a designation of a class of items of goods or services, and wherein the processor is arranged to restrict the amount of financial value to use for purchase of an item of goods or services selected from the class.

25. Apparatus according to claim 20, wherein the processor is arranged to restrict a second user from modifying the designated data.

26. Apparatus according to claim 20, wherein the data port is arranged to receive an indication of an amount of financial value to be associated with one of the data fields in which are stored the designated data, and wherein the processor is arranged to use the amount of financial value to enable a purchase that is in accordance with the designated data.

27. Apparatus according to claim 20, wherein the data port is arranged to receive the designation of the data from a remote site by means of an electronic network.

28. Apparatus according to claim 20, wherein the memory, data port, and processor are arranged in a single integrated unit, which is adapted to be physically presented to a vendor in order to enable a purchase.

29. Apparatus according to claim 20, wherein the memory is arranged to have one or more additional data fields, the one or more additional data fields corresponding to respective purchase characteristics, wherein the data port is arranged to receive from the user a designation of data to be stored in at least one of the one or more additional data fields, and wherein the processor is arranged to disallow a financial transaction responsive to data designated by the user which are stored in the one or more additional data fields.

30. Apparatus according to claim 29, wherein the data port is arranged to receive from the user a designation of a geographical limitation to be stored in one of the one or more additional data fields.

31. Apparatus according to claim 29, wherein the data port is arranged to receive from the user a designation of a time-related limitation to be stored in one of the one or more additional data fields.

32. A computer program product for enabling financial transactions, the product comprising a computer-readable medium having program instructions embodied therein, which instructions, when read by a computer, cause the computer to provide an electronic monetary token having one or more data fields associated therewith, the one or more data fields defining respective characteristics of an item of goods or services for purchase, such that a user of the token is enabled to designate data to be stored in at least one of the one or more data fields, so as to restrict items for which the token can be used to make a purchase.

33. A computer program product according to claim 32, wherein the one or more data fields include a first set of one or more data fields, wherein the instructions, when read by the computer, cause the computer to:
enable the first set of one or more data fields to have a first amount of financial value associated therewith;
provide a second set of one or more data fields associated with the electronic monetary token, the second set of one or more data fields defining respective characteristics of a second item of goods or services for purchase; and
enable the second set of one or more data fields to have a second amount of financial value associated therewith,
such that the user is enabled to designate data to be stored in at least one of the data fields in the second set of one or more data fields, so as to restrict items for which the second amount of financial value can be used to make a purchase.

34. A computer program product according to claim 32, wherein the instructions, when read by the computer, cause the computer to restrict a second user from modifying the designated data.

35. A computer program product according to claim 32, wherein the instructions, when read by the computer, cause the computer to enable the user to assign an age limitation to be stored in one of the one or more data fields, so as to restrict the token from being used to purchase an item having an age designation not corresponding to the age limitation.

36. A computer program product according to claim 32, wherein the instructions, when read by the computer, cause the computer to:
enable the token to have an amount of financial value associated therewith; and
enable the user to designate a particular item of goods or services, such that the amount of financial value is restricted to use for purchase of the particular item.

37. A computer program product according to claim 32, wherein the instructions, when read by the computer, cause the computer to:
enable the token to have an amount of financial value associated therewith; and
enable the user to designate a class of items of goods or services, such that the amount of financial value is restricted to use for purchase of an item of goods or services selected from the class.

38. A computer program product according to claim 32, wherein the instructions, when read by the computer, cause the computer to:
associate with the token a memory of the computer that is remote from the user; and
store the designated data in the memory.

39. A computer program product according to claim 32, wherein the instructions, when read by the computer, cause the computer to enable the token to be used to facilitate a micro-payment.

40. A computer program product according to claim 32, wherein the instructions, when read by the computer, cause the computer to restrict a recipient to whom the token was transferred from modifying the data designated by the user.

41. A computer program product according to claim 40, wherein the instructions, when read by the computer, cause the computer to enable the user to modify the designated data.

42. A computer program product according to claim 32, wherein the instructions, when read by the computer, cause the computer to enable the user to associate an amount of financial value with the designated data.

43. A computer program product according to claim 42, wherein the instructions, when read by the computer, cause the computer to receive at a Web site a designation by the user of the data and a designation of the value.

44. A computer program product according to claim 32, wherein the instructions, when read by the computer, cause the computer to:
receive, with respect to the electronic monetary token, an authorization query including transaction data corresponding to a proposed transaction;
analyze the transaction data with respect to the designated data; and
bar use of the electronic monetary token to enable the proposed transaction, responsive to analyzing the transaction data.

45. A computer program product according to claim 44, wherein the instructions, when read by the computer, cause the computer to receive the query from a vendor over an electronic network.

46. A computer program product according to claim 32, wherein the instructions, when read by the computer, cause the computer to provide one or more additional data fields associated with the token, the one or more additional data fields defining respective purchase characteristics, such that the user is enabled to designate data to be stored in at least one of the one or more additional data fields, so as to restrict the token from being used to enable purchases having aspects corresponding to the purchase characteristics.

47. A computer program product according to claim 46, wherein the instructions, when read by the computer, cause the computer to provide a field, selected from the one or more additional data fields, which corresponds to a geographical limitation associated with a purchase.

48. A computer program product according to claim 46, wherein the instructions, when read by the computer, cause the computer to provide a field, selected from the one or more additional data fields, which corresponds to a time-related limitation associated with a purchase.
